(19) United States
(12) Patent Application Publication
(10) Pub. No.: US 2020/0232457 A1
(43) Pub. Date: Jul. 23, 2020

(54) PUMP DEVICE

(71) Applicant: Nidec Tosok Corporation, Zama-shi, Kanagawa (JP)

(72) Inventors: Shigehiro KATAOKA, Zama-shi (JP); Yoshiyuki KOBAYASHI, Zama-shi (JP)

(73) Assignee: Nidec Tosok Corporation, Zama-shi, Kanagawa (JP)

(21) Appl. No.: 16/486,177

(22) PCT Filed: Feb. 23, 2018
(86) PCT No.: PCT/JP2018/006611

§ 371 Date: Aug. 15, 2019

(30) Foreign Application Priority Data
Mar. 3, 2017 (JP) 2017-040567

(51) Int. Cl. F04C 2/10; H02K 7/14

(52) U.S. Cl. CPC F04C 2/102; H02K 9/19; H02K 7/14

(57) ABSTRACT

A pump device includes a motor including a shaft along a central axis, a pump on one side of the motor in an axial direction and driven by the motor via the shaft to discharge oil, and an inverter circuit to drive the pump. The motor includes a housing to accommodate a rotor and a stator. The pump includes a pump rotor attached to the shaft, a pump body to accommodate the pump rotor, and a pump cover to cover an opening on one side of the pump body in the axial direction. The pump cover includes a cover extension extending from an outer edge portion of the pump cover in a radial direction and extending to the outside of a sidewall of the housing. The pump cover is provided to come into thermal contact with the inverter circuit.

### CROSS REFERENCE TO RELATED APPLICATIONS

This is a U.S. national stage of PCT Application No. PCT/JP2018/006611, filed on Feb. 23, 2018, and priority under 35 U.S.C. § 119(a) and 35 U.S.C. § 365(b) is claimed from Japanese Application No. 2017-040567, filed Mar. 3, 2017; the entire disclosures of each application are hereby incorporated herein by reference.

### FIELD OF THE INVENTION

The present invention relates to a pump device.

### BACKGROUND

In recent years, an electric oil pump used for a transmission or the like has been required to have responsiveness. In order to realize responsiveness in the electric oil pump, a motor for an electric oil pump needs to have a high output.

When the motor for an electric oil pump has a high output, an inverter configured to drive the motor needs to be designed to endure the high output. That is, an inverter using electronic parts that endure a large current is required. When a large current flows through an inverter, the electronic parts may generate heat and a temperature of the inverter may be increased. For this reason, in order to minimize an increase in temperature of the inverter, a temperature increase inhibiting structure needs to be provided in the electric oil pump.

Japanese Patent Laid-open Publication No. 2005-229658 discloses an electric pump unit in which a motor rotor is fixed to one end side of a shaft and accommodated in a motor case, an input-side gear is fixed to the other end side and the input-side gear is accommodated in a motor flange that covers the motor case.

The electric pump unit disclosed in Japanese Patent Laid-open Publication No. 2005-229658 has the motor case and a housing below a motor, and an inverter circuit (a circuit board) that is a controller is accommodated in the housing. For this reason, since the inverter circuit is disposed below the motor, it is unlikely to be affected by heat from the motor. However, the housing has no means for releasing heat generated from electronic parts mounted on the inverter circuit. For this reason, heat may be kept in the housing and the temperature of the inverter circuit may increase.

### SUMMARY

Example embodiments of the present disclosure provide pump devices each capable of reducing or minimizing a probability of an increase in temperature of an inverter circuit due to heat generated from electronic parts.

An example embodiment of the present disclosure is a pump device including a motor including a shaft rotatably supported about a central shaft extending in an axial direction, a pump disposed on one side of the motor in the axial direction and driven by the motor via the shaft to discharge oil, and an inverter circuit to drive the pump. The motor includes a housing to accommodate a rotor and a stator. The pump includes a pump rotor attached to the shaft, a pump body to accommodate the pump rotor, and a pump cover to cover an opening that opens at one side of the pump body in the axial direction. The pump cover includes a cover extension extending from an outer edge portion of the pump cover in a radial direction to the outside of a sidewall of the housing. The pump cover is provided to come into thermal contact with the inverter circuit.

According to an example embodiment of the present disclosure, it is possible to provide a pump device capable of reducing or minimizing a probability of an increase in temperature of an inverter circuit due to heat generated from electronic parts.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 illustrates a cross-sectional view of a pump device according to a first example embodiment of the present disclosure.

FIG. 2 illustrates a side view of a front side of the pump device according to the first example embodiment of the present disclosure.

FIG. 3 illustrates a cross-sectional view of a pump device according to a variant of the first example embodiment of the present disclosure.

FIG. 4 illustrates a cross-sectional view of a pump device according to a second example embodiment of the present disclosure.

FIG. 5 illustrates a cross-sectional view of a pump device according to a variant of the second example embodiment of the present disclosure.

FIG. 6 illustrates a cross-sectional view of a pump device according to a third example embodiment of the present disclosure.

FIG. 7 illustrates a cross-sectional view of a pump device according to a fourth example embodiment of the present disclosure.

FIG. 8 illustrates a cross-sectional view of a pump device according to a variant of the third example embodiment of the present disclosure.

FIG. 9 illustrates a cross-sectional view of a pump device according to a variant of the fourth example embodiment of the present disclosure.

### DETAILED DESCRIPTION

Hereinafter, pump devices according to example embodiments of the present disclosure will be described with reference to the accompanying drawings. However, dimensions, materials, shapes, relative dispositions thereof, or the like, of components disclosed as the example embodiments or shown in the drawings are merely exemplary without intending to limit the scope of the present disclosure within the above-mentioned contents. For example, expressions indicating relative or unambiguous disposition such as “in a direction,” “along a direction,” “parallel to,” “perpendicular to,” “central,” “concentric,” “coaxial,” or the like, not only represent such dispositions strictly, but also represent a state of relative displacement with a tolerance or an angle and a distance that achieve the same functions. For example, expressions indicating that subjects are equivalent such as “the same,” “equal,” “homogeneous,” and so on, not only represent strictly equal states, but also represent a tolerance or a state in which a difference is provided such that the same functions are obtained. For example, expressions indicating shapes such as a rectangular shape, a cylindrical shape, and so on, not only represent shapes such as a rectangular shape, a cylindrical shape, and so on, in a geometrically strict meaning, but also represent shapes including a concavo-convex section, chamfered sections, and so on, within a range in which the same effects are obtained. Meanwhile, an expression such as “provided with,” “include,” “comprise,” “contain” or “have” a component is not an exclusive expression that excludes the existence of other components.

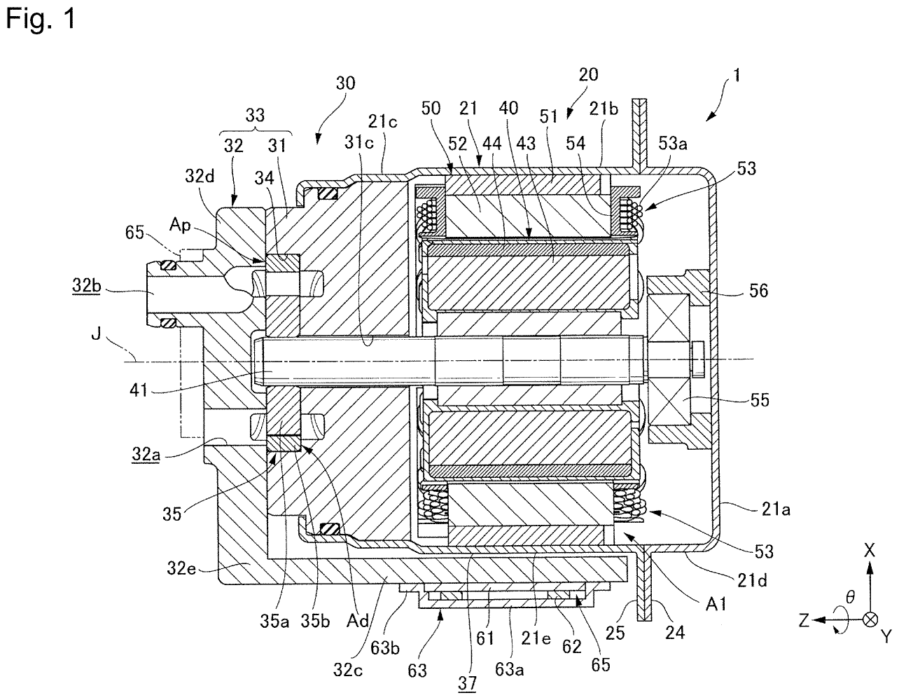

In addition, in the drawings, an XYZ coordinate system is shown as an appropriate 3-dimensional orthogonal coordinate system. In the XYZ coordinate system, a Z-axis direction is a direction parallel to one direction which is an axial direction of a central axis J shown in FIG. 1. An X-axis direction is a direction parallel to a width direction of a pump device shown in FIG. 1, i.e., a vertical direction of FIG. 1. A Y-axis direction is a direction perpendicular to both of the X-axis direction and the Z-axis direction.

In addition, in the following description, a positive side in the Z-axis direction (a +Z side) is referred to as “a front side” and a negative side in the Z-axis direction (a −Z side) is referred to as “a rear side.” Further, the rear side and the front side are terms simply used for description and do not limit a positional relation or a direction in actuality. In addition, a direction parallel to the central axis J (Z-axis direction) is simply referred to as “an axial direction,” a radial direction about the central axis J is simply referred to as “a radial direction” and a circumferential direction about the central axis J, i.e., around the central axis J (a θ direction) is simply referred to as “a circumferential direction” unless the context clearly indicates otherwise.

Further, in the specification, extending in the axial direction also includes a case of extending in a direction inclined within a range of less than 45° with respect to the axial direction, in addition to a case of extending strictly in the axial direction (the Z-axis direction). In addition, in the specification, extending in the radial direction also includes a case of extending in a direction inclined within a range of less than 45° with respect to the radial direction, in addition to a case of extending strictly in the radial direction, i.e., extending in a direction perpendicular to the axial direction (the Z-axis direction).

### First Example Embodiment

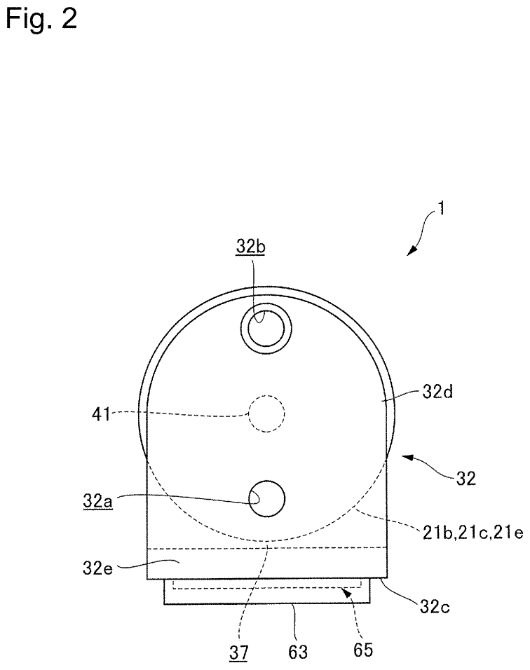

FIG. 1 illustrates a cross-sectional view of a pump device according to a first example embodiment. FIG. 2 illustrates a side view of the pump device according to the first example embodiment.

As shown in FIG. 1, the pump device 1 of the first example embodiment has a motor section 20, a pump unit 30 and an inverter circuit 65. The motor section 20 has a shaft 41 disposed along the central axis J extending in an axial direction. The pump unit 30 is disposed on one side of the motor section 20 in the axial direction, is driven by the motor section 20 via the shaft 41, and discharges oil. That is, the motor section 20 and the pump unit 30 are provided to be arranged in the axial direction. Hereinafter, each component will be described in detail.

### <Motor Section 20>

As shown in FIG. 1, the motor section 20 has a housing 21, a rotor 40, the shaft 41, a stator 50 and a bearing 55.

The motor section 20 is, for example, an inner rotor type motor, the rotor 40 is fixed to an outer circumferential surface of the shaft 41, and the stator 50 is disposed on the side outward from the rotor 40 in the radial direction. In addition, the bearing 55 is disposed on an end portion of a rear side of the shaft 41 in the axial direction (the −Z side), and rotatably supports the shaft 41.

### (Housing 21)

As shown in FIG. 1, the housing 21 is formed in a bottomed thin cylindrical shape, and has a bottom surface section 21a, a stator holding section 21b, a pump body holding section 21c, a sidewall section 21d, and flange sections 24 and 25. The bottom surface section 21a forms a bottomed portion, and the stator holding section 21b, the pump body holding section 21c and the sidewall section 21d form a cylindrical sidewall surface about the central axis J. In the example embodiment, an inner diameter of the stator holding section 21b is larger than an inner diameter of the pump body holding section 21c. An outer surface of the stator 50, i.e., an outer surface of a core back section 51 (to be described below) is fitted to an inner surface of the stator holding section 21b. Accordingly, the stator 50 is accommodated in the housing 21.

The flange section 24 expands outward from an end portion of the front side of the sidewall section 21d (the +Z side) in the radial direction. Meanwhile, the flange section 25 expands outward from an end portion of the rear side of the stator holding section 21b (the −Z side) in the radial direction. The flange section 24 and the flange section 25 face each other, and are fastened to each other by a fastening means (not shown). Accordingly, the motor section 20 and the pump unit 30 are sealed and fixed into the housing 21.

As a material of the housing 21, for example, a zinc-aluminum-magnesium-based alloy or the like can be used, and specifically, a steel plate or a steel strip plated with a molten zinc-aluminum-magnesium alloy can be used. Since the housing 21 is formed of a metal and has a large surface area with a high thermal conductivity, a heat radiation effect is excellent. In addition, a bearing holding section 56 configured to hold the bearing 55 is provided on the bottom surface section 21a.

### (Rotor 40)

The rotor 40 has a rotor core 43 and a rotor magnet 44. The rotor core 43 surrounds the shaft 41 around the axis (in a θ direction), and is fixed to the shaft 41. The rotor magnet 44 is fixed to an outer surface of the rotor core 43 around the axis (in the θ direction). The rotor core 43 and the rotor magnet 44 are rotated together with the shaft 41.

### (Stator 50)

The stator 50 surrounds the rotor 40 around the axis (in the θ direction), and rotates the rotor 40 around the central axis J. The stator 50 has the core back section 51, a teeth section 52, a coil 53 and a bobbin (an insulator) 54.

A shape of the core back section 51 is a cylindrical shape concentric with the shaft 41. The teeth section 52 extends from an inner surface of the core back section 51 toward the shaft 41. A plurality of teeth sections 52 are disposed on the inner surface of the core back section 51 at equal intervals in the circumferential direction. The coil 53 is provided around the bobbin (the insulator) 54, and has a conductive wire 53a wound thereon. The bobbins (the insulators) 54 are mounted on each of the teeth sections 52.

### (Bearing 55)

The bearing 55 is disposed on the rear side (the −Z side) of the rotor 40 and the stator 50 and held at the bearing holding section 56. The bearing 55 supports the shaft 41. A shape, a structure, or the like, of the bearing 55 is not particularly limited and any known bearing may also be used.

### <Pump Unit 30>

The pump unit 30 is disposed on one side of the motor section 20 in the axial direction, specifically, on the front side thereof (the +Z axis side). The pump unit 30 is driven by the motor section 20 via the shaft 41. The pump unit 30 is a displacement pump configured to discharge oil by increasing or decreasing a volume of a closed space. In the example embodiment, a trochoid pump is used as the displacement pump. The pump unit has a pump rotor 35, a pump body 31 and a pump cover 32. Hereinafter, the pump cover 32 and the pump body 31 are referred to as a pump case 33.

### (Pump Body 31)

The pump body 31 is fixed to a front end portion of the housing 21 on a front side of the motor section 20. The pump body 31 has a pump chamber 34 open at the front side (the +Z side), recessed on the rear side (the −Z side) and configured to accommodate the pump rotor 35. The pump body 31 is formed of a metal, and a shape of the pump chamber 34 seen in the axial direction is a circular shape. Since the pump body 31 is formed of a metal and has a large surface area with a high thermal conductivity, a heat radiation effect is excellent.

The pump body 31 has a through-hole 31c, both end of which are open in the axial direction, through which the shaft 41 passes, and having an opening on the front side that opens into the pump chamber 34. An opening of the through-hole 31c on the rear side opens on the side of the motor section 20. The through-hole 31c functions as a bearing member configured to rotatably support the shaft 41.

### (Pump Rotor 35)

The pump rotor 35 is attached to the shaft 41. More specifically, the pump rotor 35 is attached to an end portion of the shaft 41 on the front side. The pump rotor 35 has an inner rotor 35a attached to the shaft 41, and an outer rotor 35b that surrounds an outer side of the inner rotor 35a in the radial direction. The inner rotor 35a has an annular shape. The inner rotor 35a is a gear having teeth on an outer surface in the radial direction.

The inner rotor 35a is fixed to the shaft 41. More specifically, the end portion of the shaft 41 on the front side is press-fitted into the inner rotor 35a. The inner rotor 35a rotates around the axis (in the θ direction) together with the shaft 41. The outer rotor 35b has an annular shape that surrounds an outer side of the inner rotor 35a in the radial direction. The outer rotor 35b is a gear having teeth on an inner surface in the radial direction.

The inner rotor 35a and the outer rotor 35b mesh with each other, and the outer rotor 35b is rotated when the inner rotor 35a is rotated. That is, the pump rotor 35 is rotated according to rotation of the shaft 41. In other words, the motor section 20 and the pump unit 30 have the same rotary shaft. Accordingly, an increase in size of the electric oil pump in the axial direction can be minimized. In addition, when the inner rotor 35a and the outer rotor 35b are rotated, a volume between the meshed portions of the inner rotor 35a and the outer rotor 35b varies. An area in which a volume is reduced is a pressurized area Ap, and an area in which a volume is increased is a negative pressure area Ad. A pump-side suction port 32a is disposed on one side of the pump rotor 35 in the axial direction of the negative pressure area Ad. In addition, a pump-side discharge port 32b is disposed on one side of the pump rotor 35 in the axial direction of the pressurized area Ap. Here, oil suctioned into the pump chamber 34 from the pump-side suction port 32a is accommodated in a space between the inner rotor 35a and the outer rotor 35b, and delivered toward the pump-side discharge port 32b. After that, the oil is discharged from the pump-side discharge port 32b.

### (Inverter Circuit 65)

The inverter circuit 65 is configured to have a heat generating element 62 mounted on a circuit board 61, supplies electric power for driving to the coil 53 of the stator 50 of the motor section 20, and controls operations such as driving, rotation, stopping, and so on, of the motor section 20. Further, communication between the inverter circuit 65 and the coil 53 of the stator 50 due to electric power supply and an electric signal is performed due to electrical connection between the inverter circuit 65 and the coil 53 using a wiring member such as a coated cable or the like (not shown).

The circuit board 61 outputs a motor driving signal. In the example embodiment, the circuit board 61, which will be described in detail, is directly disposed on a surface of the pump cover 32 while insulation is secured. A printed wiring (not shown) is provided on the surface of the circuit board 61. In addition, heat generated in the heat generating element 62 is easily transferred by the pump cover 32 using a copper inlay substrate as the circuit board 61, and a cooling efficiency is improved.

The heat generating element 62 is mounted on a surface of the circuit board 61 on the front side (the +Z side). The heat generating element 62 is, for example, a condenser, a microcomputer, a power IC, a field effect transistor (FET), or the like. In addition, the number of heat generating elements 62 is not limited to two and may be three or more.

### (Inverter Cover 63)

An inverter cover 63 is provided on a surface of the pump cover 32 and covers the circuit board 61 and the heat generating element 62. The inverter cover 63 has a top board section 63a and a brim section 63b.

The top board section 63a comes into contact with an apex surface of the heat generating element 62 and extends in the axial direction and the Y-axis direction. The brim section 63b protrudes from an outer edge of the top board section 63a. An end surface of the brim section 63b on a back side comes in contact with a surface of a cover extension section 32c of the pump cover 32, which will be described below. When the heat generating element 62 of the inverter circuit 65 comes in direct contact with the top board section 63a of the inverter cover 63, heat generated in the heat generating element 62 can be radiated from the inverter cover 63.

The inverter cover 63 is fixed to the pump cover 32 by fastening the brim section 63b of the inverter cover 63 and the pump cover 32 using a fastening means 64 such as a bolt, a nut, or the like.

Next, a temperature increase inhibiting structure of the inverter circuit 65 provided in the pump device 1 according to the example embodiment will be described. In the example embodiment, an increase in temperature of the inverter circuit 65 can be minimized by radiating heat generated from the inverter circuit 65 using the cover extension section 32c provided in the pump cover 32.

The pump cover 32 is attached to a front side of the pump body 31. Since the pump cover 32 is formed of a metal and has a large surface area with a high thermal conductivity, a heat radiation effect is excellent. As shown in FIG. 2, the pump cover 32 has a cover body section 32d having a plate shape. In the example embodiment shown, the cover body section 32d has one side formed in a semi-circular shape and the other side formed in a rectangular shape. The cover body section 32d closes an opening of the pump chamber 34 on the front side.

As shown in FIGS. 1 and 2, the pump cover 32 has the cover extension section 32c extending from an outer edge portion 32e of the pump cover 32 in the radial direction to the outside of a sidewall 21e of the housing 21. In the example embodiment shown, the cover extension section 32c extends from the other edge portion of the cover body section 32d toward the other side of the motor section 20 in the axial direction (the rear side) along the stator holding section 21b and the pump body holding section 21c of the housing 21. That is, the pump cover 32 has the cover body section 32d and the cover extension section 32c. For this reason, the cover extension section 32c has a large surface area, is formed of a metal, and has a large thermal conductivity. Accordingly, a heat radiation effect can be further increased by the cover extension section 32c.

In the example embodiment shown in FIGS. 1 and 2, the cover extension section 32c extends in a plate shape. The cover extension section 32c has a rectangular shape and extends from a front end of the pump unit 30 toward a near side of a rear end of the motor section 20 when seen in a side view. The cover extension section 32c extends with respect to the pump body 31 of the pump unit 30 and the housing 21 of the motor section 20 with a gap 37 therebetween. That is, the cover extension section 32c is not in contact with the pump body 31 and the housing 21. The inverter circuit 65 is provided on the cover extension section 32c to come in contact with the cover extension section 32c.

Accordingly, heat generated from the inverter circuit 65 is transferred to the cover extension section 32c and the cover body section 32d to be radiated. Here, since the cover extension section 32c extends from the front side to the rear side of the pump device 1, the entire surface area of the pump cover 32 is increased. For this reason, heat generated from the inverter circuit 65 is efficiently radiated via the cover extension section 32c. Accordingly, an increase in temperature of the inverter circuit 65 can be minimized. In addition, since the cover extension section 32c extends along the housing 21, the cover extension section 32c can be disposed close to the housing 21, and an increase in size of the pump device 1 can be minimized.

In addition, in the pump unit 30, oil suctioned from the pump-side suction port 32a flows to the pump-side discharge port 32b through the pump chamber 34 according to rotation of the pump rotor 35. For this reason, heat transferred to the cover extension section 32c and the cover body section 32d is absorbed by the oil when a temperature of the oil flowing through the pump unit 30 is lower than that of the heat generated from the inverter circuit 65. For this reason, the heat generated from the inverter circuit 65 is further efficiently radiated via the oil flowing through the pump unit 30. Accordingly, an increase in temperature of the inverter circuit 65 can be minimized.

Further, while the case in which the inverter circuit 65 is provided on the cover extension section 32c has been described in the above-mentioned example embodiment, there is no limitation thereto. As shown by a two-dot dashed line in FIG. 1, the inverter circuit 65 may be provided on the cover body section 32d to come in contact with the cover body section 32d. In this case, the inverter circuit 65 is disposed at a position that avoids the pump-side suction port 32a and the pump-side discharge port 32b. In this case, since the cover body section 32d is formed of a metal and has a large surface area with a high thermal conductivity, the heat generated from the inverter circuit 65 is efficiently radiated via the cover body section 32d and the cover extension section 32c. In addition, the heat generated from the inverter circuit 65 is further efficiently radiated via the oil flowing through the pump unit 30. Accordingly, an increase in temperature of the inverter circuit 65 can be further minimized.

In addition, as shown in FIG. 1, the cover extension section 32c has an area Al that overlaps the housing 21 and the stator 50 in the axial direction. In addition, the housing 21 is formed of a metal and has a large surface area with a high thermal conductivity. For this reason, the heat generated from the stator 50 is radiated via the housing 21 and transferred to the cover extension section 32c via the gap 37 to be radiated from the cover extension section 32c. Accordingly, the heat generated from the inverter circuit 65 and the heat generated from the stator 50 are efficiently radiated via the cover extension section 32c and the housing 21. In addition, the heat generated from the inverter circuit 65 and the heat generated from the stator 50 are further efficiently radiated via the oil flowing through the pump unit 30. Accordingly, an increase in temperature of the inverter circuit 65 can be minimized.

### Variant of First Example Embodiment

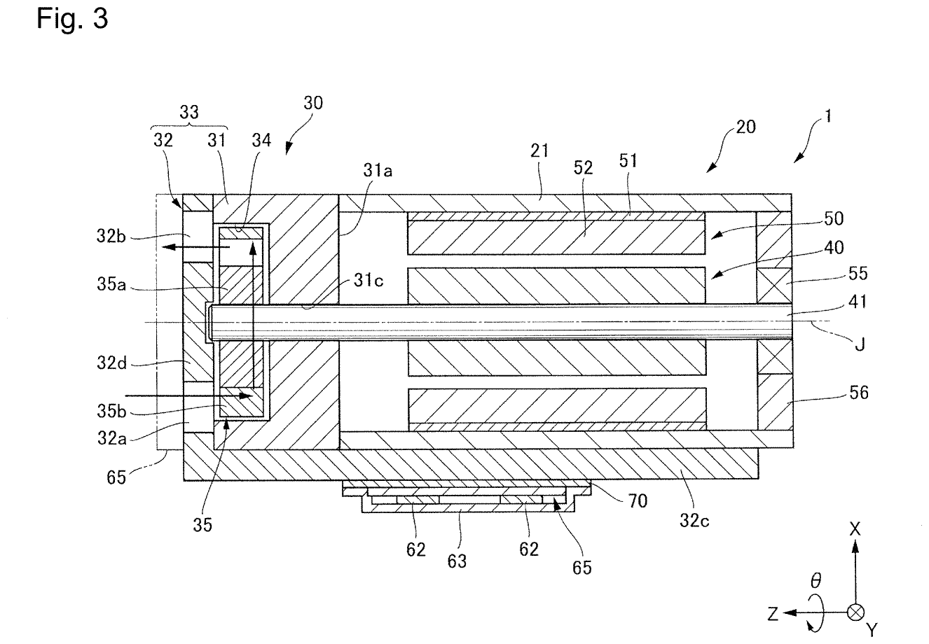

FIG. 3 illustrates a cross-sectional view of a pump device according to a variant of the first example embodiment. In the pump device 1 shown in FIG. 3, the housing 21 of the motor section 20 comes into contact with and is connected to the other end portion of the pump unit 30 in the axial direction of the pump body 31. In addition, the bearing holding section 56 of the motor section 20 is provided to be fitted into the other end portion of the housing 21 in the axial direction.

In addition, while the cover extension section 32c is disposed to have the gap 37 between it and the housing 21 in FIG. 1, the cover extension section 32c may be disposed to come in contact with the housing 21 as shown in FIG. 3. In this case, since the cover extension section 32c has a plate shape and the pump body 31 and the housing 21 have a cylindrical shape, the cover extension section 32c comes in contact with the pump body 31 and the housing 21 in a straight line. In the example embodiment, the cover extension section 32c comes in line contact with the pump body 31 and the housing 21. Further, the cover extension section 32c may come in surface contact with the pump body 31 and the housing 21.

In this way, since both of the housing 21 and the cover extension section 32c are formed of a metal, a heat transfer efficiency between them can be increased by bringing the housing 21 and the cover extension section 32c in contact with each other. Accordingly, since an increase in temperature of the motor section 20 is further minimized, heat of the inverter circuit 65 can be more efficiently radiated via the cover extension section 32c. In addition, the heat generated from the inverter circuit 65 can be further efficiently radiated via the oil flowing through the pump unit 30. Accordingly, an increase in temperature of the inverter circuit 65 can be further minimized.

In addition, as shown in FIG. 3, the inverter circuit 65 may be provided on the cover extension section 32c to come in contact with the cover extension section 32c via a heat radiation member 70. The heat radiation member 70 is a thermosetting resin having a high thermal conductivity such as a silicone rubber or the like, a heat radiation sheet, heat radiation grease, or the like. A contact area of the inverter circuit 65 with respect to the cover extension section 32c is increased by providing the heat radiation member 70 between the inverter circuit 65 and the cover extension section 32c. For this reason, heat generated from the inverter circuit 65 can be more efficiently transferred to the cover extension section 32c.

### Second Example Embodiment

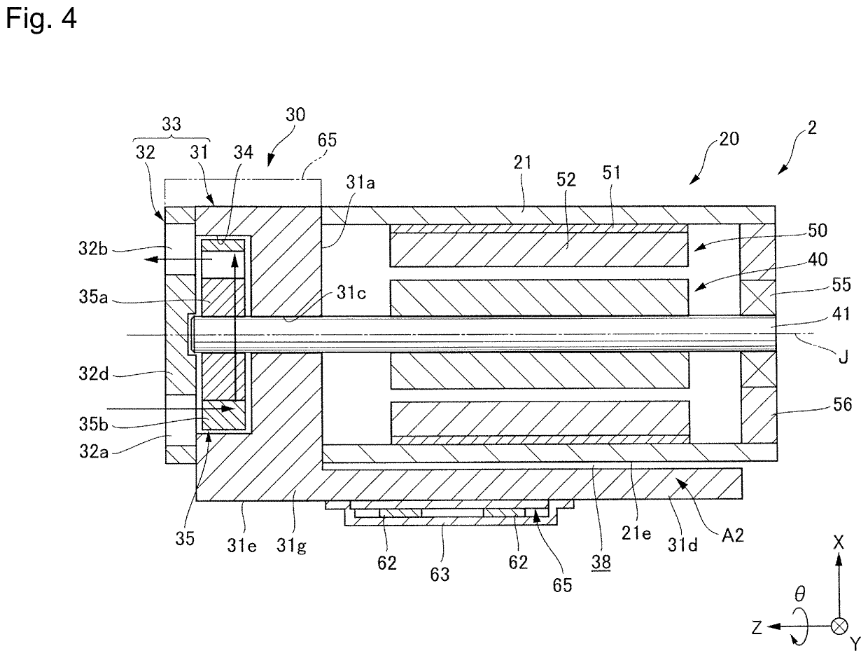

FIG. 4 illustrates a cross-sectional view of a pump device according to a second example embodiment. In the second example embodiment, only different points from the variant (FIG. 3) of the above-mentioned first example embodiment will be described, and parts the same as those of the variant of the first example embodiment are designated by the same reference numerals and description thereof will be omitted.

As shown in FIG. 4, a pump unit 30 of a pump device 2 of the second example embodiment has a body extension section 31d extending from an outer edge portion 31g of the pump body 31 in the radial direction along an outer side of the sidewall 21e of the housing 21.

In the example embodiment shown in FIG. 4, the body extension section 31d extends from the outer edge portion 31g of the pump body 31 in the radial direction to the other side (the rear side) of the motor section 20 in the axial direction along the sidewall 21e of the housing 21. The body extension section 31d is formed in a plate shape having a rectangular shape when seen in a side view. The body extension section 31d is formed of a metal and has a large surface area with a high thermal conductivity. The body extension section 31d extends with respect to the housing 21 of the motor section 20 with a gap 38. That is, the body extension section 31d is in non-contact with the housing 21.

The inverter circuit 65 is provided to come into thermal contact with the body extension section 31d. In the example embodiment shown, the inverter circuit 65 is provided to come in contact with the body extension section 31d.

Accordingly, the heat generated from the inverter circuit 65 is transferred to the body extension section 31d and a main body section 31e to be radiated. In addition, the heat generated from the stator 50 is also transferred to the housing 21 and the body extension section 31d to be radiated. Here, since the body extension section 31d has a plate shape extending from the front side to the rear side of the pump device 2, the entire surface area of the pump unit 30 is increased. For this reason, the heat generated from the inverter circuit 65 is efficiently radiated via the body extension section 31d. Accordingly, an increase in temperature of the inverter circuit 65 can be minimized.

In addition, the heat transferred to the body extension section 31d and the main body section 31e is absorbed by the oil passing through the pump unit 30, when a temperature of the oil is lower than that of the heat. For this reason, the heat generated from the inverter circuit 65 is further efficiently radiated via the oil flowing through the pump unit 30. Accordingly, an increase in temperature of the inverter circuit 65 can be minimized.

Further, while the case in which the inverter circuit 65 is provided on the body extension section 31d has been described in the above-mentioned example embodiment, there is no limitation thereto. As shown by a two-dot dashed line in FIG. 4, the inverter circuit 65 may be provided to bring the inverter circuit 65 in contact with a side surface of the main body section 31e of the pump body 31. In this case, since the main body section 31e and the body extension section 31d are formed of a metal, the thermal conductivity is large and the surface area is large. For this reason, the heat generated from the inverter circuit 65 is transferred to the main body section 31e and the body extension section 31d to be efficiently radiated. In addition, when the temperature of the oil flowing through the pump unit 30 is lower than that of the heat, the heat is absorbed by the oil. For this reason, the heat generated from the inverter circuit 65 is further efficiently radiated via the oil flowing through the pump unit 30.

In addition, in the example embodiment shown, the body extension section 31d has an area A2 that overlaps the housing 21 and the stator 50 in the axial direction. Here, since the housing 21 is formed of a metal and has a high thermal conductivity, the heat generated from the stator 50 is radiated via the housing 21 and transferred to the body extension section 31d via the gap 38. Further, in heat transfer through the gap 38, the heat generated from the stator 50 is transferred to the body extension section 31d through convection of air. For this reason, the heat generated from the stator 50 can be radiated via the body extension section 31d. Accordingly, an increase in temperature of the motor section 20 is minimized, and radiation of the heat of the inverter circuit 65 via the body extension section 31d is accelerated. Thus, an increase in temperature of the inverter circuit 65 can be minimized.

### Variant of Second Example Embodiment

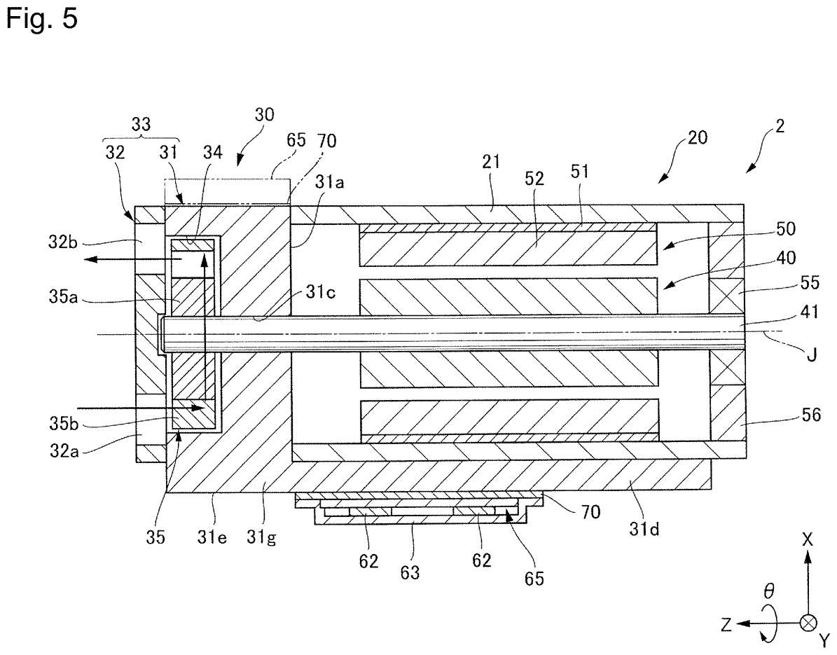

In FIG. 4, while the body extension section 31d is disposed to have the gap 38 with respect to the housing 21, the body extension section 31d may be disposed to come in contact with the housing 21 as shown in FIG. 5. In this case, since the body extension section 31d has a plate shape and the housing 21 has a cylindrical shape, the body extension section 31d comes in line contact with the housing 21. Further, the body extension section 31d may come in surface contact with the housing 21. Accordingly, the heat generated from the stator 50 is efficiently transferred to the body extension section 31d from the housing 21. For this reason, an increase in temperature of the motor section 20 is minimized, and radiation of heat of the inverter circuit 65 via the body extension section 31d is accelerated. Accordingly, an increase in temperature of the inverter circuit 65 can be minimized.

In addition, while the case in which the inverter circuit 65 is provided to come in direct contact with the body extension section 31d or the main body section 31e has been described in the example embodiment shown in FIG. 4, the inverter circuit 65 may be provided to come in contact with the body extension section 31d or the main body section 31e via the heat radiation member 70 as shown in FIG. 5.

When the inverter circuit 65 is provided on the main body section 31e or the body extension section 31d via the heat radiation member 70, a contact area between the inverter circuit 65 and the main body section 31e or the body extension section 31d can be increased. For this reason, the heat generated from the inverter circuit 65 can be more efficiently transferred to the main body section 31e or the body extension section 31d.

### Third Example Embodiment

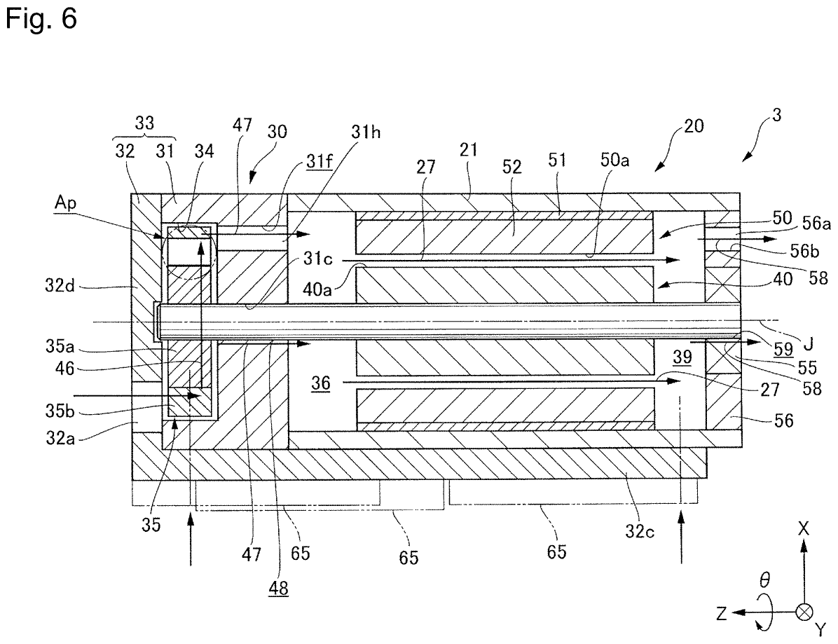

FIG. 6 illustrates a cross-sectional view of a pump device 3 according to a third example embodiment.

In the third example embodiment, only different points from the variant (see FIG. 3) of the above-mentioned first example embodiment will be described, and the same portions as those of the variant of the first example embodiment are designated by the same reference numerals and description thereof will be omitted. In the third example embodiment, since oil having a constant temperature (for example, 120° C.) or less flows through the pump unit 30 and the motor section 20, when the heat generated from the inverter circuit 65 is radiated via the oil, minimization of increase in temperature of the inverter circuit 65 is realized.

In the example embodiment shown in FIG. 6, a delivery hole 31f configured to connect the pump chamber 34 and the inside of the motor section 20 is formed in the pump body 31. An opening of the delivery hole 31f on the side of the pump unit is disposed on the pressurized area Ap of the pump rotor 35. For this reason, the oil suctioned by the pump unit 30 is delivered to the motor section 20 via the delivery hole 31f. Further, the pump-side discharge port 32b shown in FIG. 3 is not provided in the pump cover 32.

In addition, a motor-side discharge port 56a capable of discharging the oil delivered into the motor section 20 is provided in the bearing holding section 56 fitted to an end portion of the housing 21 on the rear side. The motor-side discharge port 56a is open at the other end in the axial direction of a through-hole 56b passing through the bearing holding section 56. In addition, a cooling flow path 27 through which the oil can flow is provided between an inner circumferential surface 50a of the stator 50 and an outer circumferential surface 40a of the rotor 40. Further, a space section 36 on the front side capable of storing the oil delivered from the delivery hole 31f is provided on the front side in the housing 21. In addition, a space section 39 on the rear side capable of storing the oil delivered from the cooling flow path 27 is provided on the rear side in the housing 21. For this reason, the space section 39 on the rear side and the through-hole 56b communicate with each other, and the oil in the motor section 20 can be discharged from the motor-side discharge port 56a through the through-hole 56b. Here, a flow path configured to discharge the oil in the motor section 20 from the motor-side discharge port 56a is referred to as a second flow path 58.

Meanwhile, the pump unit 30 has a pump flow path 46 through which the oil suctioned from the pump-side suction port 32a flows to the delivery hole 31f through the pump chamber 34 according to rotation of the pump rotor 35. In addition, the oil having a constant temperature (for example, 120° C.) or less flows through the pump unit 30 and the motor section 20.

In the example embodiment shown in FIG. 6, the inverter circuit 65 is disposed in an area overlapping the cover extension section 32c and the pump flow path 46 in the axial direction of the motor section 20.

In this case, when the pump device 3 is driven, the oil suctioned from the pump-side suction port 32a of the pump unit 30 flows through the pump flow path 46 and is delivered to the space section 36 on the front side in the motor section 20 through the delivery hole 31f. Here, a flow path through which the oil flows to the delivery hole 31f is referred to as a first flow path 47. The oil delivered to the space section 36 on the front side flows through the cooling flow path 27 and is delivered to the space section 39 on the rear side and discharged from the motor-side discharge port 56a. When the oil flows through the pump flow path 46, since the temperature of the oil is the constant temperature (for example, 120° C.) or less, when the temperature of the heat generated from the inverter circuit 65 is higher than the temperature of the oil, the oil absorbs the heat generated from the inverter circuit 65 and cools the inverter circuit 65. In addition, the heat generated from the inverter circuit 65 is radiated via the cover body section 32d and the cover extension section 32c. For this reason, the heat generated from the inverter circuit 65 is more efficiently absorbed by the oil flowing through the pump flow path 46 and the cover extension section 32c. Accordingly, an increase in temperature of the inverter circuit 65 can be further minimized.

In addition, the inverter circuit 65 may be disposed on an area overlapping the cover extension section 32c and the cooling flow path 27 in the axial direction of the motor section 20. In the example embodiment shown, the inverter circuit 65 is disposed on the rear side of the cover extension section 32c.

In this case, when the pump device 1 is driven and the oil flowing through the pump flow path 46 is delivered to the space section 36 on the front side via the delivery hole 31f, the oil delivered to the space section 36 on the front side flows through the cooling flow path 27 and is delivered to the space section 39 on the rear side. Here, when the oil flows through the cooling flow path 27, the oil absorbs the heat generated from the stator 50 and cools the stator 50, and absorbs the heat generated from the inverter circuit 65 and cools the inverter circuit 65. In addition, the heat generated from the inverter circuit 65 is radiated via the cover extension section 32c. For this reason, the heat generated from the inverter circuit 65 is efficiently absorbed by radiation from the cover extension section 32c and absorption to the oil. Accordingly, an increase in temperature of the inverter circuit 65 can be further minimized.

In addition, the inverter circuit 65 may be disposed on an area overlapping the cover extension section 32c, the pump flow path 46 and the cooling flow path 27 in the axial direction of the motor section 20. In the example embodiment shown, the inverter circuit 65 is disposed on the cover extension section 32c while crossing the pump unit 30 and the motor section 20.

In this case, when the pump device 1 is driven, the oil suctioned from the pump-side suction port 32a of the pump unit 30 flows through the pump flow path 46, and is delivered into the motor section 20 via the delivery hole 31f to flow through the cooling flow path 27. Here, when the oil flows through the pump flow path 46, the oil absorbs the heat generated from the inverter circuit 65 and cools the inverter circuit 65. In addition, the heat generated from the inverter circuit 65 is radiated via the cover body section 32d and the cover extension section 32c. In addition, when the oil flows through the cooling flow path 27, the oil absorbs the heat generated from the stator 50 and absorbs the heat generated from the inverter circuit 65. In addition, the heat generated from the inverter circuit 65 and the heat generated from the stator 50 are radiated via the cover extension section 32c. For this reason, the heat generated from the inverter circuit 65 is absorbed by heat absorption of the oil flowing through the pump unit 30 and the motor section 20 and heat radiation from the cover extension section 32c. Accordingly, an increase in temperature of the inverter circuit 65 can be minimized.

In addition, while the case in which the flow path through which the oil flows to the delivery hole 31f is the first flow path 47 has been described in the above-mentioned example embodiment, the first flow path 47 may be a flow path passing through a gap 48 between the shaft 41 passing through the through-hole 31c formed in the pump body 31 and the through-hole 31c. In this case, the delivery hole 31f is not provided, and the oil supplied from the pump rotor 35 flows into the gap 48 from the opening of the through-hole 31c on the side of the pump rotor 35 to flow through the first flow path 47, and flows into a motor section 10 (the space section 36). When the first flow path 47 is the gap 48 between the shaft 41 and the through-hole 31c, a structure of the pump body 31 can be simplified, and an increase in manufacturing processes and manufacturing costs of the pump unit 30 can be minimized.

Further, the first flow path 47 is the gap 48 between the shaft 41 and the through-hole 31c. For this reason, when the shaft 41 is supported via a bearing provided in the through-hole 31c, the first flow path 47 may be provided in the bearing or may be a gap between the bearing and the shaft 41.

In addition, while the case in which the second flow path 58 is a flow path configured to discharge the oil in the motor section 10 from the motor-side discharge port 56a has been described in the above-mentioned example embodiment, the second flow path 58 may be a flow path passing through a gap between the shaft 41 passing through the bearing member provided in the bearing holding section 56 and the bearing member. In the example embodiment shown in FIG. 6, the bearing member is the bearing 55. In this case, the through-hole 56b and the motor-side discharge port 56a are not provided, and the oil flowing through the cooling flow path 27 between the rotor 40 and the stator 50 of the motor section 20 flows into the space section 39, and then, flows through a gap 59 between the shaft 41 and the bearing 55, i.e., the second flow path 58. For this reason, when the second flow path 58 is the gap 59 between the shaft 41 and the bearing 55, since the motor-side discharge port 56a is unnecessary, a structure of the motor section 20 can be more simplified, and an increase in manufacturing processes and manufacturing costs of the motor section 20 can be minimized.

### Fourth Example Embodiment

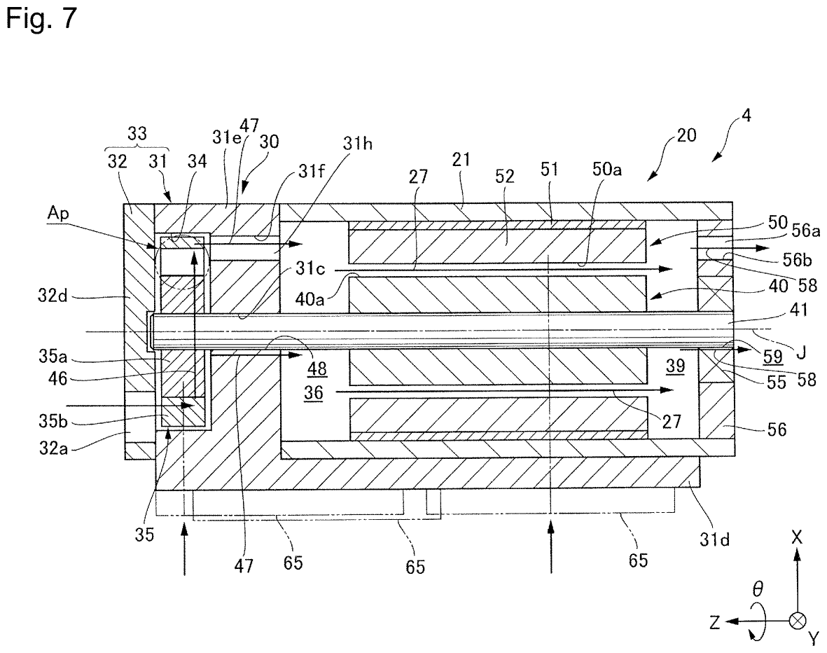

FIG. 7 illustrates a cross-sectional view of a pump device according to a fourth example embodiment.

In the fourth example embodiment, only different points from the variant (see FIG. 5) of the above-mentioned second example embodiment will be described, and the same portions as those of the variant of the second example embodiment will be designated by the same reference numerals and description thereof will be omitted.

In the example embodiment shown in FIG. 7, the delivery hole 31f configured to connect the pump chamber 34 and the inside of the motor section 20 is provided in the pump body 31. An opening of the delivery hole 31f on the side of the pump unit is disposed on the pressurized area Ap of the pump rotor 35. For this reason, the oil suctioned by the pump unit 30 is delivered into the motor section 20 via the delivery hole 31f. Further, the pump-side discharge port 32b shown in FIG. 5 is not provided in the pump cover 32.

In addition, a through-hole 56b capable of discharging oil delivered into the motor section 20 is provided in the bearing holding section 56 fitted to an end portion of the housing 21 on the rear side. The motor-side discharge port 56a opens at the other end of the through-hole 56b in the axial direction. In addition, the cooling flow path 27 through which oil can flow is provided between the inner circumferential surface 50a of the stator 50 and the outer circumferential surface 40a of the rotor 40. In addition, the space section 36 on the front side capable of storing oil delivered from the delivery hole 31f is provided on the front side in the housing 21. In addition, the space section 39 on the rear side capable of storing oil delivered from the cooling flow path 27 is provided on the rear side in the housing 21. The space section 39 on the rear side and the motor-side discharge port 56a are connected to each other. Here, a flow path through which oil flows in the delivery hole 31f is referred to as the first flow path 47. In addition, a flow path configured to discharge the oil in the motor section 20 from the motor-side discharge port 56a is referred to as the second flow path 58.

The inverter circuit 65 is disposed on an area overlapping the body extension section 31d and the pump flow path 46 in the axial direction of the motor section 20. In this case, when a pump device 4 is driven, the oil suctioned from the pump-side suction port 32a of the pump unit 30 flows through the pump flow path 46 and flows through the cooling flow path 27 in the motor section 20 through the delivery hole 31f. When the oil flows through the pump flow path 46, the heat generated from the inverter circuit 65 is absorbed and cooled by the oil flowing through the pump flow path 46 via the pump body 31. In addition, the heat generated from the inverter circuit 65 is radiated via the main body section 31e and the body extension section 31d. For this reason, the heat generated from the inverter circuit 65 is more efficiently absorbed by the oil flowing through the pump flow path 46 and the pump body 31 having the body extension section 31d. Accordingly, an increase in temperature of the inverter circuit 65 can be minimized.

In addition, the inverter circuit 65 may be disposed on an area overlapping the body extension section 31d and the cooling flow path 27 in the axial direction of the motor section 20. In this case, when the pump device 4 is driven, the oil delivered to the space section 36 on the front side via the delivery hole 31f flows through the cooling flow path 27. When the oil flows through the cooling flow path 27, the oil absorbs the heat generated from the stator 50 and cools the stator 50, and absorbs the heat generated from the inverter circuit 65 and cools the inverter circuit 65. In addition, the heat generated from the inverter circuit 65 is radiated via the pump body 31 having the body extension section 31d. For this reason, the heat generated from the inverter circuit 65 is more efficiently absorbed by heat radiation from the pump body 31 having the body extension section 31d and heat absorption of the oil flowing through the cooling flow path 27. Accordingly, an increase in temperature of the inverter circuit 65 can be further minimized.

Further, the inverter circuit 65 may be disposed on an area overlapping the body extension section 31d, the pump flow path 46 and the cooling flow path 27 in the axial direction of the motor section 20. In this case, when the pump device 1 is driven, the oil suctioned from the pump-side suction port 32a of the pump unit 30 flows through the pump flow path 46, and is delivered into the motor section 20 to flow through the cooling flow path 27 via the delivery hole 31f. When the oil flows through the pump flow path 46, the oil absorbs the heat generated from the inverter circuit 65 and cools the inverter circuit 65. In addition, the heat generated from the inverter circuit 65 is radiated via the pump body 31 having the body extension section 31d. In addition, when the oil flows through the cooling flow path 27, the oil absorbs the heat generated from the stator 50 and cools the stator 50, and absorbs the heat generated from the inverter circuit 65 and cools the inverter circuit 65. In addition, the heat generated from the inverter circuit 65 is radiated via the pump body 31 having the body extension section 31d. For this reason, the heat generated from the inverter circuit 65 is absorbed by heat absorption of the oil flowing through the pump unit 30 and the motor section 20 and hear radiation from the pump body 31 having the body extension section 31d. Accordingly, an increase in temperature of the inverter circuit 65 can be further minimized.

Further, while the case in which the flow path through which the oil passes through the delivery hole 31f is the first flow path 47 has been described in the fourth example embodiment, the first flow path 47 may be a flow path passing through the gap between the shaft 41 passing through the through-hole 31c provided in the pump body 31 and the through-hole 31c. Description in this case will be omitted because it has been described in the third example embodiment.

In addition, while the case in which the second flow path 58 is a flow path configured to discharge the oil in the motor section 10 from the motor-side discharge port 56a has been described in the fourth example embodiment, the second flow path 58 may be a flow path passing through the gap between the shaft 41 passing through the bearing member (the bearing 55) provided in the bearing holding section 56 and the bearing member. Description in this case will be omitted because it has been described in the third example embodiment.

### Variant of Third Example Embodiment

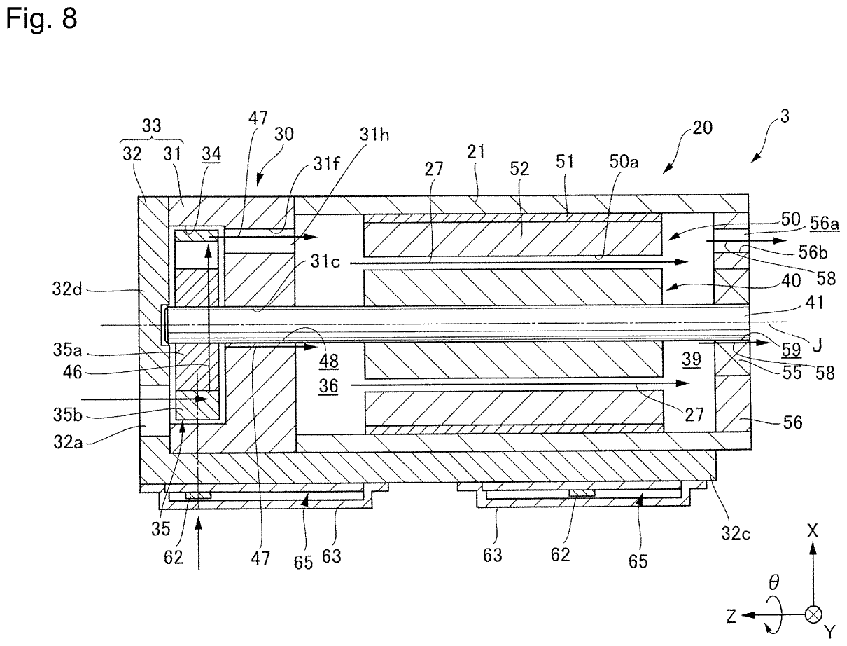

Next, a variant of the pump device 3 (see FIG. 6) according to the third example embodiment will be described. FIG. 8 illustrates a cross-sectional view of the pump device 3 according to the variant of the third example embodiment. While the inverter circuit 65 has been described in the above-mentioned third example embodiment, the heat generating element 62 is provided on the inverter circuit 65, and the heat generating element 62 is disposed on an area overlapping the cover extension section 32c and the pump flow path 46 in the axial direction of the motor section 20.

As shown in FIG. 8, the inverter circuit 65 provided with the heat generating element 62 is provided on the cover extension section 32c. The heat generating element 62 is, for example, an electrolytic condenser, a shunt resistor, or the like. In this case, the heat generated from the heat generating element 62 is radiated from the pump body 31 having the cover extension section 32c and absorbed by the oil flowing through the pump unit 30. For this reason, the heat generated from the heat generating element 62 is more efficiently absorbed. Accordingly, an increase in temperature of the inverter circuit 65 can be minimized.

In addition, in the example embodiment shown, the heat generating element 62 may be disposed on an area overlapping the cover extension section 32c and the cooling flow path 27 in the axial direction of the motor section 20. In this case, the heat generated from the heat generating element 62 is radiated from the pump body 31 having the cover extension section 32c, and absorbed by the oil flowing through the cooling flow path 27 of the motor section 20. For this reason, the heat generated from the heat generating element 62 is more efficiently absorbed. Accordingly, an increase in temperature of the inverter circuit 65 can be minimized.

In addition, while not shown, the heat generating element 62 may be disposed on an area overlapping the cover extension section 32c, the pump flow path 46 and the cooling flow path 27 in the axial direction of the motor section 20. In this case, the heat generated from the heat generating element 62 is radiated from the pump body 31 having the cover extension section 32c and absorbed by the oil flowing through the pump flow path 46 of the pump unit 30 and the oil flowing through the cooling flow path 27 of the motor section 20. For this reason, the heat generated from the heat generating element 62 is more efficiently absorbed. Accordingly, an increase in temperature of the inverter circuit 65 can be further minimized.

Further, as described in the third example embodiment, the first flow path 47 may be a flow path passing through the gap between the shaft 41 passing through the through-hole 31c provided in the pump body 31 and the through-hole 31c. Description in this case will be omitted because it has been described in the third example embodiment.

In addition, as described in the third example embodiment, the second flow path 58 may be a flow path passing through a gap between the shaft 41 passing through a bearing member (the bearing 55) provided in the bearing holding section 56 and the bearing member. Description in this case will be omitted because it has been described in the third example embodiment.

### Variant of Fourth Example Embodiment

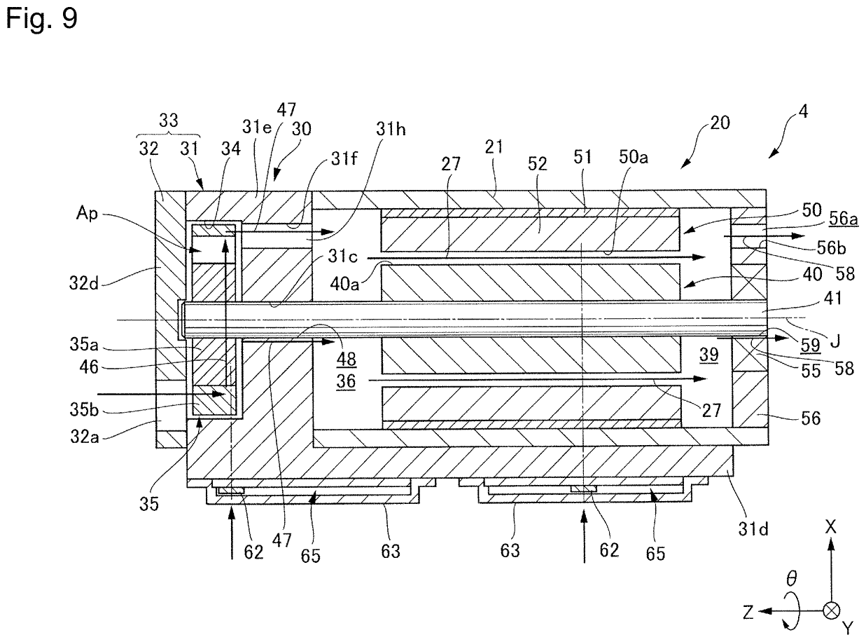

Next, a variant of the pump device 4 (see FIG. 7) according to the fourth example embodiment will be described. FIG. 9 illustrates a cross-sectional view of the pump device 4 according to the variant of the fourth example embodiment. While the inverter circuit 65 has been described in the above-mentioned fourth example embodiment, the heat generating element 62 may be provided on the inverter circuit 65, and the heat generating element 62 may be disposed on an area overlapping the body extension section 31d and the pump flow path 46 in the axial direction of the motor section 20.

As shown in FIG. 9, the inverter circuit 65 provided with the heat generating element 62 is provided on the body extension section 31d. The heat generating element 62 is, for example, an electrolytic condenser, a shunt resistor, or the like. In this case, the heat generated from the heat generating element 62 is radiated from the pump body 31 having the body extension section 31d and absorbed by the oil flowing through the pump flow path 46. For this reason, the heat generated from the heat generating element 62 is more efficiently absorbed. Accordingly, an increase in temperature of the inverter circuit 65 can be minimized.

In addition, in the example embodiment shown, the heat generating element 62 may be disposed on an area overlapping the body extension section 31d and the cooling flow path 27 in the axial direction of the motor section 20. In this case, the heat generated from the heat generating element 62 is radiated from the pump body 31 having the body extension section 31d and absorbed by the oil flowing through the cooling flow path 27 of the motor section 20. For this reason, the heat generated from the heat generating element 62 is more efficiently absorbed. Accordingly, an increase in temperature of the inverter circuit 65 can be minimized.

Further, while not shown, the heat generating element 62 may be disposed on an area overlapping the cover extension section 32c, the pump flow path 46 and the cooling flow path 27 in the axial direction of the motor section 20. In this case, the heat generated from the heat generating element 62 is radiated from the pump body 31 having the cover extension section 32c and absorbed by the oil flowing through the pump flow path 46 of the pump unit 30 and the oil flowing through the cooling flow path 27 of the motor section 20. For this reason, the heat generated from the heat generating element 62 is more efficiently absorbed. Accordingly, an increase in temperature of the inverter circuit 65 can be further minimized.

Further, as described in the fourth example embodiment, the first flow path 47 may be a flow path passing through the gap between the shaft 41 passing through the through-hole 31c provided in the pump body 31 and the through-hole 31c. Description in this case will be omitted because it has been described in the fourth example embodiment.

Further, as described in the fourth example embodiment, the second flow path 58 may be a flow path passing through a gap between the shaft 41 passing through a bearing member (the bearing 55) provided in the bearing holding section 56 and the bearing member. Description in this case will be omitted because it has been described in the fourth example embodiment.

Hereinabove, while the preferred example embodiments of the present disclosure have been described, the present disclosure is not limited to the example embodiments and various modifications and changes may be made without departing from the spirit of the present disclosure.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-22. (canceled)

23. A pump device comprising:
a motor including a shaft disposed along a central axis extending in an axial direction;
a pump disposed on one side of the motor in the axial direction and driven by the motor via the shaft to discharge oil; and
an inverter circuit to drive the pump; wherein
the motor includes a housing to accommodate a rotor and a stator;
the pump includes:
a pump rotor attached to the shaft;
a pump body to accommodate the pump rotor; and
a pump cover to cover an opening that opens at one side of the pump body in the axial direction; wherein
the pump cover includes a cover extension extending from an outer edge portion of the pump cover in a radial direction to an outside of a sidewall of the housing; and
the pump cover is provided to come into thermal contact with the inverter circuit.

24. The pump device according to claim 23, wherein the cover extension extends from the outer edge portion of the pump cover in the radial direction toward the other side of the motor in the axial direction along the sidewall of the housing.

25. A pump device comprising:
a motor including a shaft rotatably supported about a central axis extending in an axial direction;
a pump disposed on one side of the motor in the axial direction and driven by the motor via the shaft to discharge oil; and
an inverter circuit to drive the pump; wherein
the motor includes a housing to accommodate a rotor and a stator;
the pump includes:
a pump rotor attached to the shaft;
a pump body to accommodate the pump rotor; and
a pump cover to cover an opening that opens at one side of the pump rotor in the axial direction; wherein
the pump body includes a body extension extending from an outer edge portion of the pump body in a radial direction to an outside of a sidewall of the housing; and
the pump body is provided to come into thermal contact with the inverter circuit.

26. The pump device according to claim 25, wherein the body extension extends from the outer edge portion of the pump body in the radial direction toward the other side of the motor in the axial direction along the sidewall of the housing.

27. The pump device according to claim 23, wherein the inverter circuit is provided to come into thermal contact with the cover extension.

28. The pump device according to claim 25, wherein the inverter circuit is provided to come into thermal contact with the body extension.

29. The pump device according to claim 23, wherein the cover extension includes an area overlapping the housing and the stator in the axial direction.

30. The pump device according to claim 25, wherein the body extension includes an area overlapping the housing and the stator in the axial direction.

31. The pump device according to claim 23, wherein the inverter circuit is provided to come into contact with the pump cover via a heat radiator including an insulating property.

32. The pump device according to claim 25, wherein the inverter circuit is provided to come into contact with the pump body via a heat radiator including an insulating property.

33. The pump device according to claim 23, wherein
the pump includes a pump flow path through which the oil flows in the pump;
the motor includes a cooling flow path to introduce the oil flowing through the pump into the motor; and
the inverter circuit is disposed in an area overlapping the cover extension and the pump flow path in the axial direction of the motor.

34. The pump device according to claim 23, wherein
the pump includes a pump flow path through which the oil flows in the pump;
the motor includes a cooling flow path to introduce the oil flowing through the pump into the motor; and
the inverter circuit is disposed in an area overlapping the cover extension and the cooling flow path in the axial direction of the motor.

35. The pump device according to claim 23, wherein
the pump includes a pump flow path through which the oil flows in the pump;
the motor includes a cooling flow path to introduce the oil flowing through the pump into the motor; and
the inverter circuit is disposed in an area overlapping the cover extension, the pump flow path and the cooling flow path in the axial direction of the motor.

36. The pump device according to claim 25, wherein
the pump includes a pump flow path through which the oil flows in the pump;
the motor includes a cooling flow path capable of introducing the oil flowing through the pump into the motor and cooling the motor by using the oil; and
the inverter circuit is disposed in an area overlapping the body extension and the pump flow path in the axial direction of the motor.

37. The pump device according to claim 25, wherein
the pump includes a pump flow path through which the oil flows in the pump;
the motor includes a cooling flow path capable of introducing the oil flowing through the pump into the motor and cooling the motor by using the oil; and
the inverter circuit is disposed in an area overlapping the body extension and the cooling flow path in the axial direction of the motor.

38. The pump device according to claim 25, wherein
the pump includes a pump flow path through which the oil flows in the pump;
the motor includes a cooling flow path capable of introducing the oil flowing through the pump into the motor and cooling the motor by using the oil; and
the inverter circuit is disposed in an area overlapping the body extension, the pump flow path and the cooling flow path in the axial direction of the motor.

39. The pump device according to claim 36, wherein the pump includes:
the pump body including a through-hole passing through the shaft and disposed to face the motor;
a pump-side delivery port to deliver the oil into the motor; and
a first flow path to deliver the oil into the motor using pressurization of the pump from the pump-side delivery port; and
the first flow path passes through a gap between the through-hole and the shaft passing through the through-hole.

40. The pump device according to claim 36, wherein the motor includes:
a motor-side discharge port provided on the motor;
a second flow path to discharge the oil in the motor from the motor-side discharge port; and
a bearing held at an end portion of the housing on the other side in the axial direction and to rotatably support the shaft; and
the second flow path passes through a gap between the shaft and the bearing.

41. The pump device according to claim 33, wherein the inverter circuit includes a heater located in an area overlapping the cover extension and the pump flow path in the axial direction of the motor.

42. The pump device according to claim 34, wherein the inverter circuit includes a heater located in an area overlapping the cover extension and the pump flow path in the axial direction of the motor.
